(19) United States
(12) Patent Application Publication
(10) Pub. No.: US 2023/0210725 A1
(43) Pub. Date: Jul. 6, 2023

(54) PHARMACEUTICAL BOTTLE AND DUAL LOCK CAP WITH MEMORY SNAPTAB SYSTEM AND METHOD OF USING SAME

(71) Applicant: Levi Princeton Rockefeller, Whittier, CA (US)

(72) Inventor: Levi Princeton Rockefeller, Whittier, CA (US)

(21) Appl. No.: 18/150,732

(22) Filed: Jan. 5, 2023

Related U.S. Application Data
(60) Provisional application No. 63/296,787, filed on Jan. 5, 2022.

(51) Int. Cl. A61J 7/04; B65D 25/20

(52) U.S. Cl. CPC A61J 7/04; B65D 25/205; B65D 2203/12

(57) ABSTRACT

A pharmacy cap for tracking medication for a user has a body and a ring with removable tabs indicating dosage information. A pharmacy bottle or sleeve for displaying dosage information to a patient with removable tabs. A method for using a pharmacy system provides a series of removable tabs indicating dosage information that are removed sequentially according to dosage information.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57. This application claims the benefit of priority to U.S. Provisional Patent Application No. 63/296,787, filed on Jan. 5, 2022, the entire contents of which are herein incorporated in their entirety.

### BACKGROUND

### Field

This disclosure relates to the field of pharmaceuticals, containers, packaging, and administration of medication. In particular, this disclosure relates to a pharmaceutical bottle used by pharmacies and medical patients while administering medically prescribed pills packaged in a plastic bottle.

### Description of the Related Art

A patient may wish to have a reminder as a means to enhance memory to improve management of prescription medications and scheduling. Systems and methods described herein relate to bottles and accompanying means to improve user experience.

### SUMMARY

Certain aspects of this disclosure are defined by the independent claims. The dependent claims include optional features of some embodiments of the disclosure. The systems, methods, and devices described herein each have several aspects, no single one of which is solely responsible for its desirable attributes. Without limiting the scope of this disclosure, several non-limiting features will now be discussed briefly.

Details of one or more implementations of the subject matter described in this specification are set forth in the accompanying drawings and the description below. Other features, aspects, and advantages will become apparent from the description, the drawings, and the claims. Neither this summary nor the following detailed description purports to define or limit the scope of the inventive subject matter.

In one aspect described herein, a smart pharmacy cap comprises a body having a top surface and a continuous wall defining an inner surface and an outer surface; an attachment feature positioned on the inner surface of the continuous wall, wherein the attachment feature may be removably coupled to a compatible feature on a bottle; a ring affixed around the outer surface of the continuous wall, the ring further comprising a plurality of removable tabs indicating a set of dosage information to a patient; and wherein the plurality of removable tabs is configured to be individually removed from the ring by the patient according to the set of dosage information.

In another aspect described herein, a method for using a smart pharmacy system, comprises providing a plurality of removable tabs affixed to a medication container, wherein the plurality of removable tabs is arranged sequentially to indicate a set of dosage information to a patient; removing, by the patient, a single tab from the plurality of removable tabs that corresponds to a dosage time based on the set of dosage information; and wherein removing the single tab is performed iteratively based on the set of dosage information until the plurality of removable tabs is removed.

In one aspect described herein, a smart pharmacy bottle comprises a container having a base and a continuous wall defining an inner volume, the container further comprises an opening positioned opposite the base, the opening providing access to the inner volume; a cap releasably connected to the container at the opening; a ring affixed around the cap, the ring further comprising a plurality of removable tabs indicating a set of dosage information to a patient; and wherein the plurality of removable tabs is configured to be individually removed from the ring by the patient according to the set of dosage information.

In another aspect described herein, a smart pharmacy bottle comprises a container having a base and a continuous wall defining an inner volume, the container further comprises an opening positioned opposite the base, the opening providing access to the inner volume; a ring positioned around the continuous wall of the container externally to the inside volume, the ring further comprising a plurality of removable tabs indicating a set of dosage information to a patient; and wherein the plurality of removable tabs is configured to be individually removed by the patient according to the set of dosage information.

In some embodiments, the ring is shaped to resemble a virus molecule.

In some embodiments, the set of dosage information is indicated to the patient through a set of textured characters on the plurality of removable tabs.

In some embodiments, the set of textured characters comprises numbers and letters.

In some embodiments, the removable tabs are aligned on a plane perpendicular to the continuous wall of the container.

In some embodiments the removable tabs are aligned on a plane parallel to the continuous wall of the container.

In another aspect described herein, a smart pharmacy bottle comprises a container having a base and a continuous wall defining an inner volume, wherein the wall has an outer surface; a sleeve slidably positioned around the outer surface of the continuous wall; a ring affixed around the sleeve, the ring further comprising a plurality of removable tabs indicating a set of dosage information to a patient; and wherein the plurality of removable tabs is configured to be individually removed from the ring by the patient according to the set of dosage information.

### BRIEF DESCRIPTION OF THE DRAWINGS

In the drawings, which are not necessarily to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a perspective view of an embodiment of a pharmacy bottle with a memory snap-tab system on the cap in use.

FIG. 2A is a representative perspective view of an embodiment of a pharmacy bottle with a memory snap-tab system.

FIG. 2B is a representative side view of the embodiment of the pharmacy bottle from FIG. 2A.

FIG. 2C is a representative top view of the embodiment of the pharmacy bottle from FIG. 2A.

FIG. 2D is a representative perspective oblique view of the embodiment of the pharmacy bottle from FIG. 2A illustrated in use.

FIG. 3A is a representative perspective view of an alternative embodiment of a pharmacy bottle with a memory snap-tab system.

FIG. 3B is a representative top view of the alternative embodiment of the pharmacy bottle from FIG. 3A.

FIG. 3C is a representative side view of the alternative embodiment of the pharmacy bottle from FIG. 3A.

FIG. 3D is a representative perspective oblique view of the alternative embodiment of the pharmacy bottle from FIG. 3A illustrated in use.

FIG. 4A is a representative side view of an embodiment of a pharmacy bottle cap with a dual lock and memory snap-tab system.

FIG. 4B is a representative perspective view of the embodiment of the pharmacy bottle cap from FIG. 4A.

FIG. 4C is a representative perspective view of the embodiment of the pharmacy bottle cap from FIG. 4A illustrated in use.

FIG. 5 is a representative perspective view of a pharmacy bottle cap with a single lock and a memory snap-tab system.

FIG. 6A is a representative perspective view of an embodiment of a pharmacy bottle with a sleeve and a memory snap system.

FIG. 6B is a representative perspective view of the embodiment of the pharmacy bottle with sleeve from FIG. 6A illustrated in use.

### DETAILED DESCRIPTION

A better understanding of different embodiments may be had from the following description, read in conjunction with the accompanying drawings, in which like reference characters refer to like elements.

Embodiments of pharmaceutical bottles are disclosed herein. Although certain illustrative embodiments are shown in the drawings and will be described below in detail, the claims are not limited to these embodiments. However, there is no intention to limit the disclosure to the specific embodiments disclosed. On the contrary, the intention is to cover all modifications, alternative constructions, combinations, and equivalents falling within the spirit and scope of the disclosure and defined by the appended claims.

Unless a term is expressly defined in this patent to possess a described meaning, there is no intent to limit the meaning of such term, either expressly or indirectly, beyond its plain or ordinary meaning. Any element in a claim that does not explicitly state “means for” performing a specified function, or “step for” performing a specific function, is not to be interpreted as a “means” or “step” clause as specified in 35 U.S.C. § 112, paragraph 6.

Statistics show that memory loss is on the rise across the world with about 55 million people having dementia. Over 60% of these 55 million individuals live in low- and middle-income countries. The proportion of older people in the population is increasing in nearly every country, and the number of individuals with dementia is expected to rise to 78 million by 2030 and 139 million by 2050. Millions of patients forget to take prescribed medications, or alternatively, overdose on their prescriptions due to forgetfulness or confusion.

Disclosed herein are embodiments of a smart pharmacy bottle that can be used, for example, to convey information by physical evidence to the patient. The information conveyed would be clear and understandable. One aspect of the embodiments incorporates a compact, built-in memory system that is part of the botte structure. Certain configurations of the memory system may utilize a series of breakable tabs, such as Simple & Safe snap-tabs™ The tabs may be broken off upon each administered dose of a prescribed medication serving as a reminder to the patient by conveying progress via physical evidence. Breakable snap tabs may help the user recall the time or date of the last administered dose of medication.

Another aspect of the embodiments disclosed herein includes textured characters or easy to read braille on the snap tabs. Characters may include numbers, symbols, or letters as another way to help identify the dates or times affiliated with each of the tabs. Additionally, patterned snap tabs provide a new form of communication between the bottle and patient for individuals who may be blind, have mild cognitive impairment, make mistakes due to onset of Alzheimer's, or individuals with amnesia or dementia.

The memory snap-tab system provides the additional benefit as a practical and simple reminder to prevent overdose or death with concise messages to the patient. An additional benefit of such a memory system includes minimizing the amount of information, warnings, and messages being conveyed in writing on a prescription bottle. Some of the information typically conveyed in writing on the bottle label or bag in which the bottle is packaged may instead by conveyed to the patient on removable tabs via the memory system.

As an example of an attempt to add more information to the label, U.S. Pat. No. 7,311,205 by Adler et al shows a generally wedge-shaped bottle with a curved top that allows the label to be wrapped thereover. The bottle opening is at the bottom. Due to a recess between the label and the bottle, additional product information can be inserted in that recess. However, since the bottle as shown in U.S. Pat. No. 7,311,205 has been on the market it has received a large amount of criticism by the consuming public. Unlike Adler's bottle, the present disclosure does not utilize or attempt to add more information on a label, therefore, there is no opportunity for the same criticism by the consuming public.

One of the largest manufacturers of containers for prescription drugs is Berry Plastics Corporation. While Berry Plastics has a complete line of prescription containers that can be selected by “family” or “size” on their website of www.berryplastics.com, the containers have the problem of insufficient room to put all of the information concerning the medication on the container so it can be seen by the patient. The most common line by Berry Plastics is the “Friendly & Safe” prescription container with the locking top. The Friendly & Safe prescription containers come in a number of different sizes. Regardless of the size, the problem of sufficient surface area to put all of the information needed on a pharmacy container still exists. Again, unlike Berry Plastic's “Friendly & Safe” prescription container problem of sufficient surface area to put all the information needed on a pharmacy container, there is no opportunity for the same problem with the present disclosure because the prescription bottle with built-in breakable memory snap-tabs communicates quick and effective information to the patient by providing hard physical evidence that is clear and immediately understandable by touch and sight.

While a lack of space to put proper warnings, reminders and/or information on the prescription container is a problem, many patients take their medication by shape of the pill, shape of the bottle or other external factors other than reading the label itself. If there are multiple people in the household taking prescription medication, such as an elderly couple, sometimes the individuals get confused and takes the other persons medication. While various systems have been devised to avoid the confusion, mistakes still occur. That said, the present disclosure provides real solution by its breakable memory snap-tabs that act as a reminder of the last administered dose likely limiting the chance of overdose or even death.

The best reminder system would be one the patient can devise for themself. For example, an elderly couple, both of whom take prescription medication, might have different colors for their bottles or caps. As an example, the wife can take the color red and the husband take the color green. Therefore, all of the medication in the red capped container is for the wife and all of the medication in the green capped container is for the husband.

Another example may be different colors being used as reminders of when to take the medication. The color black could be used for medication to be taken in the evening and the color white for medication to be taken in the morning. Whatever system is being used, there is a drastic need to convey information in an easy-to-understand form to the patient that is taking the prescription medication. Some information such as warnings should be given in detail. However, other information such as whose medication it is may be conveyed by colors. Whatever system is used, the object is to convey the maximum amount of information to the patient in a manner the patient can absorb and utilize. Again, while various systems have been devised to avoid the confusion, a dumb-proof, Simple and Safe memory snap-tab™ system may remind patient of the last administered dose likely limiting confusion or mistakes that still occur.

It is an object of the present disclosure to provide a pharmacy bottle for a prescription medication where all of the vertical surfaces may be used to convey information to the patient. However, even when conveying the maximum amount information on vertical surfaces, the pharmacy bottle may also contain a slot where additional information may be inserted. In another embodiment, the pharmacy bottle may contain a built-in medication reminder system utilizing snap-tabs for each day of the week for the month.

A new pharmacy bottle for prescription medication finally designed to provide a maximized reminder system that is clear and understandable and communicates quickly and effectively to the patient using the prescription bottle itself. While all of the vertical surfaces for the prescription bottle are still available to receive labels adhered thereto, the memory snap-tab system may contain information to be conveyed to the patient such as (a) day of the week, (b) week of the month, (c) servings per day, (d) servings per month, (e) numbered days of the month, (f) Notice of when to request refill. These are just some of the information that should be conveyed to the patient or pharmacist about the prescription medication.

For the less observant patient that does not read the information contained on the label, and/or suffers confusion or memory loss due to Alzheimer's, dementia, amnesia, or for some other reason, the bottle or cap may incorporate a colored memory snap-tab system. The most common type of prescription bottle cap is sold under the mark “Friendly & Safe” by Berry Plastics Corporation. The Friendly & Safe cap has interlocking tabs and probably constitutes the majority of the caps used in the pharmacy industry for prescription medication in solid form such as pills or tablets. By having interlocking extensions that fit in the indentations of the Friendly & Safe cap, the memory snap-tab system can easily be attached to the cap. The colored ring of snap-tabs could then be selected based upon the preferences of the patient. For example, if more than one patient lives in a household, each of which has their own prescription medication, a different colored cap can be used by each patient. When picking up the medication, the appropriately colored cap could incorporate the Simple & Safe snap-tab™ System.

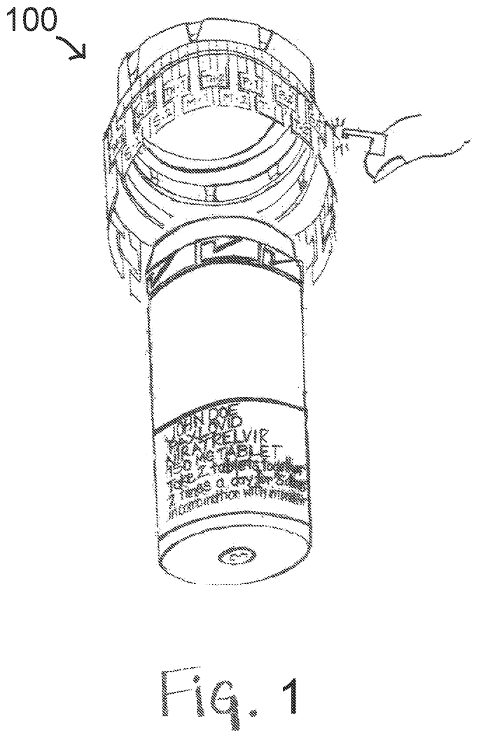

Referring to FIG. 1, a perspective view of an embodiment of a pharmacy bottle with a memory snap-tab system on the cap is pictured in use. The memory snap-tab system 100 is shown as a medication container and a lid with removable tabs affixed. In some embodiments, a user may remove tabs from the memory system as a way to remember their progress in a treatment.

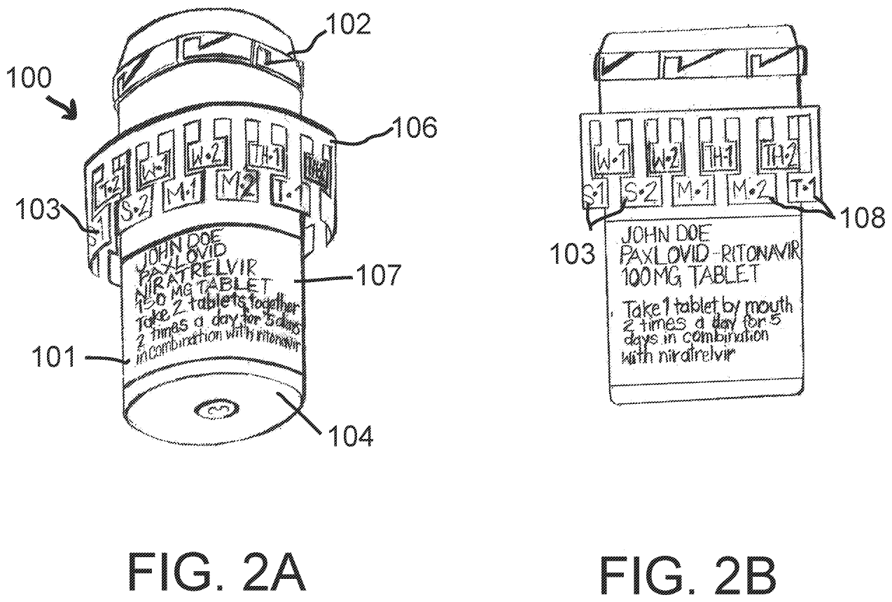

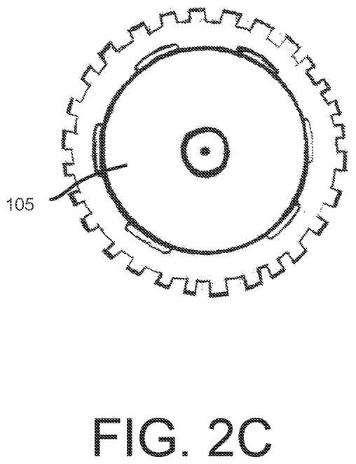

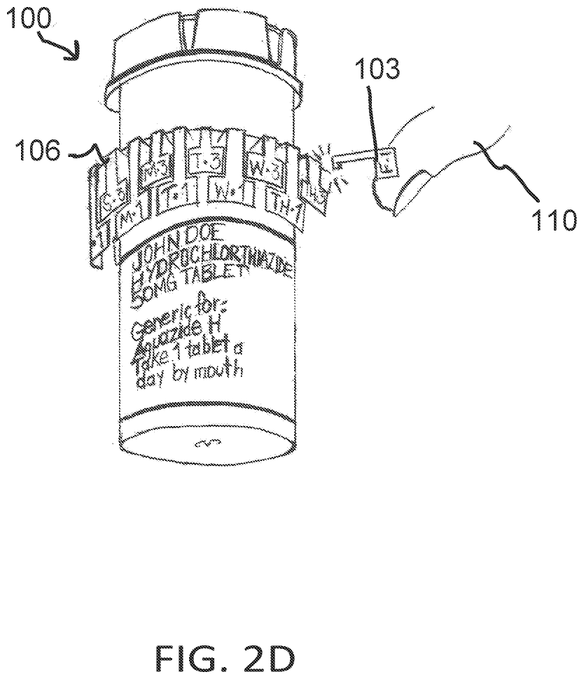

Referring to FIG. 2A, a perspective view of an embodiment of a pharmacy bottle with a memory snap-tab system is shown. In some embodiments the smart pharmacy bottle 100 may have a container 101 with features 102, such as threads, to allow a cap to removably couple the container. Additionally, the container may have a base 104 in connection with a continuous wall 107 defining an inner volume 105. The container may be used in some embodiments to store a medication or pills. The pharmacy bottle 100 may be outfitted with a memory system affixed to the outside of the container wall 107. The memory system comprises a ring 106 with a series of removable tabs 103. The removable tabs 103 may contain a set of characters 108, such as numbers, letters, or symbols, indicating to the patient a set of dosage information.

Referring to FIG. 2B, a representative side view of the embodiment of the pharmacy bottle from FIG. 2A is illustrated. The removable tabs 103 may be aligned around the ring with equal distance between them. Additionally, there may be multiple rows of removable tabs to better convey a timeline to the patient.

FIG. 2C is a representative top view of the embodiment of the pharmacy bottle from FIG. 2A. The container wall and base create an inner volume 105 for the container where medication may be stored. The inner volume may be sealed by application of a removable cap.

FIG. 2D is a representative perspective oblique view of the embodiment of the pharmacy bottle from FIG. 2A illustrated in use. In some embodiments, the user 110 may break off the removable tabs 103 on the cap by lifting the tab upward with a finger and snapping them free from the ring 106.

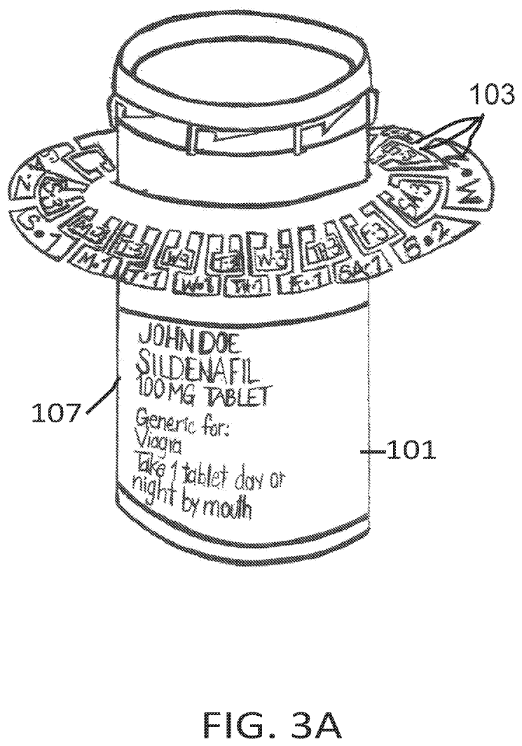

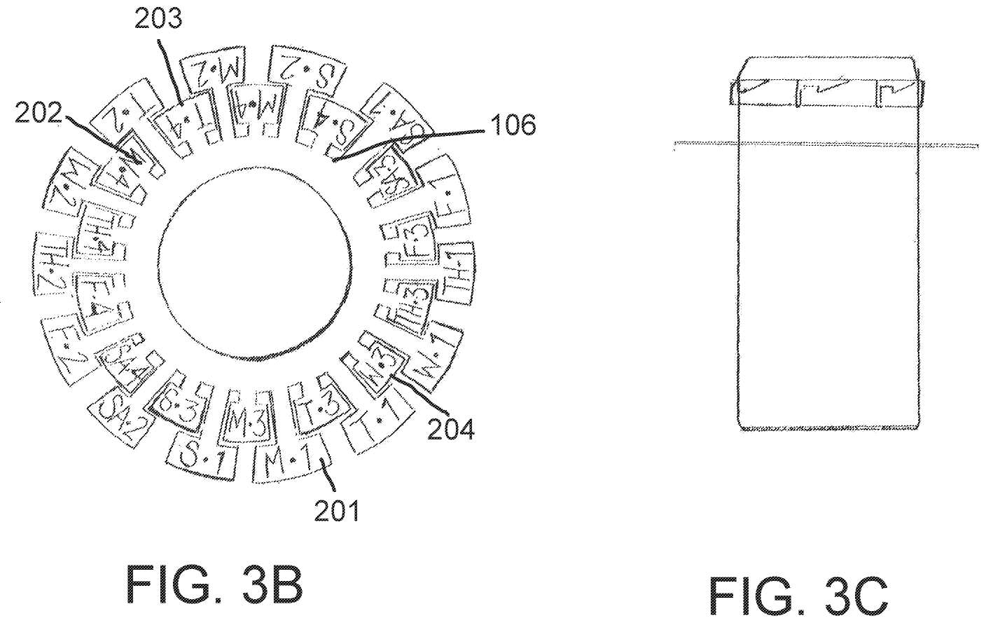

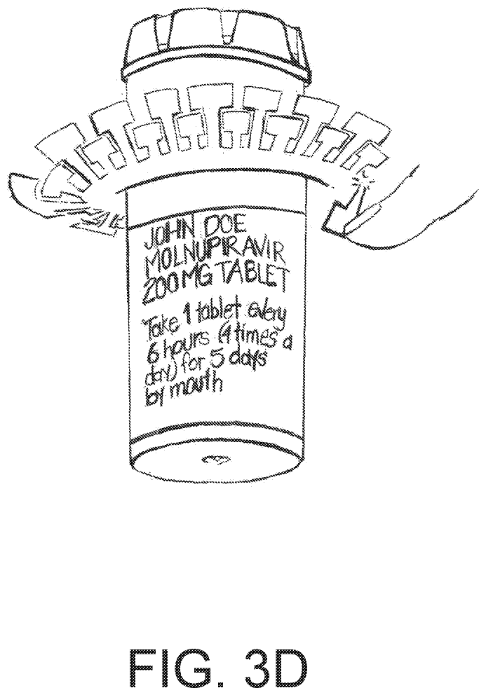

FIG. 3A is a representative perspective view of an alternative embodiment of a pharmacy bottle with a memory snap-tab system. In some embodiments, the pharmacy bottle may be molded or arranged to resemble the shape of a COVID molecule. A unique bottle structure may indicate the contents of the container more clearly to the user.

Unlike the ring and arrangement of removable tabs as in FIG. 2A, the ring may still be affixed to the container, but the removable tabs 103 may be oriented in a plane perpendicular to the container wall 107, such as illustrated in FIG. 3A. When tabs are arranged out from the container 101, the tabs 103 may be arranged in rows that are can only be removed in a particular order. Such a mechanism helps with reminding a patient the order and frequency with which to dose the medication.

Referring to FIG. 3B, a representative top view of the alternative embodiment of the pharmacy bottle is illustrated as in FIG. 3A. As previously described, some removable tabs may be positioned around the ring in several layers or rows. In FIG. 3B, the snap tabs are aligned in two rows on ring 106 to guide the dosage of medication over the course of a certain period. The first row 201 contains enough tabs for each day of the week for two weeks, or 14 tabs. Each of the tabs may be labeled with a weekday and a week number, such as Tuesday “T” and second week “2” as shown at 203. In some instances, these first row 201 tabs would be removed first, in sequential order, by the user. The second row 202 contains enough tabs for each day of the week for two weeks, or 14 tabs. Similar to the tabs in the first row 201, the tabs in the second row may be labeled with a day of the week and a week number, such as W 3, indicating the Wednesday of the third week 204. In some embodiments, the second row 202 tabs would not be accessible for removal until the first row 201 tabs are removed. This memory system requires a user to remove tabs and take medication in a specific order.

FIG. 3C is a representative side view of the alternative embodiment of the pharmacy bottle from FIG. 2A.

FIG. 3D is a representative perspective oblique view of the alternative embodiment of the pharmacy bottle from FIG. 3A illustrated in use. Similar to the embodiment in FIG. 2D, a user may break off snap tabs of the pharmacy bottle in FIG. 3D by using a finger to push the tab downward and away from the cap. In some embodiments the second row tabs may be nested in between the first row tabs making the second row inaccessible until the first row is removed.

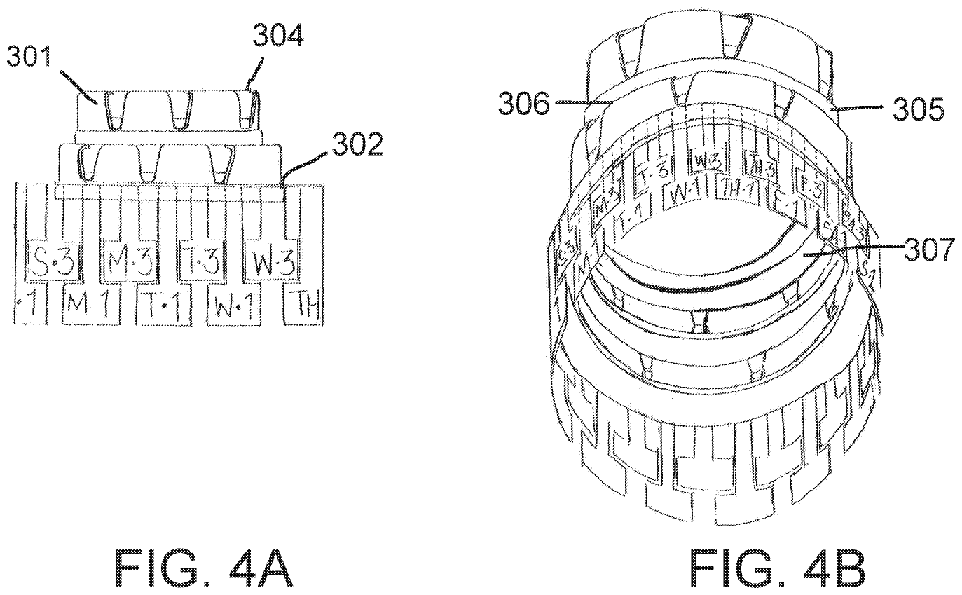

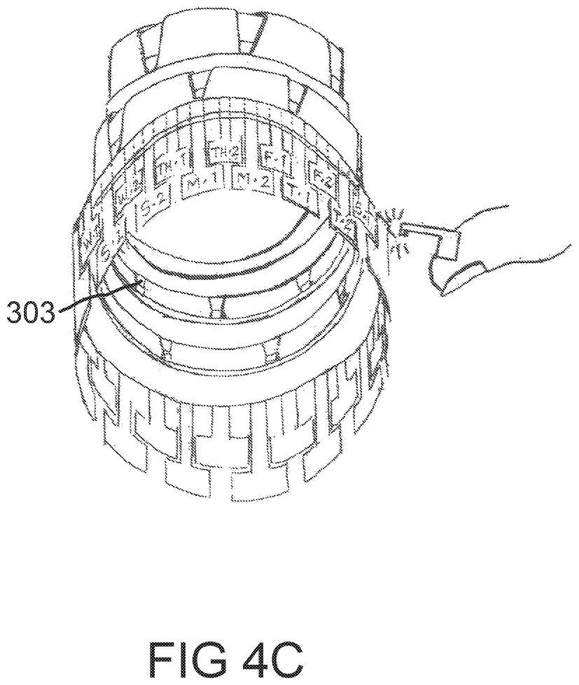

FIG. 4A is a representative side view of an embodiment of a pharmacy bottle cap with a dual lock and memory snap-tab system. In some embodiments, the removable tabs 103 may be affixed to a ring 302 connected to a cap 301. The cap 301 may have a top surface 304 and a continuous wall 305 defining an outer surface 306 and an inner surface 307. The cap 301 may be removably coupled to the container by features or some attachment means, explained in more detail below, such as threads, press fit, snap top, or a sliding mechanism. The removable tabs may be affixed to the cap to allow more space on the container for other information.

FIG. 4B is a representative perspective view of the embodiment of the pharmacy bottle cap from FIG. 4A. In some embodiments, the snap tab pharmacy bottle may have a dual locking lid designed to fit multiple different bottle sizes. The memory snap system and tabs may be marked to convey days, weeks, and/or months depending on the medication schedule of the patient.

Referring to FIG. 4C, a representative perspective view of the embodiment of the pharmacy bottle cap from FIG. 4A is illustrated in use. In some embodiments, the cap may have a dual locking mechanism to removably attach it to a medication bottle. A cap may have internal attachment features 303, like those pictured externally in FIG. 2A, that allows the cap to removably attach or lock to the top of a medication bottle. The internal attachment features 303 on the cap may be compatible with the features on the bottle. Like previously described, when removing a tab, the tab may be pushed down to snap it free from the ring or the cap.

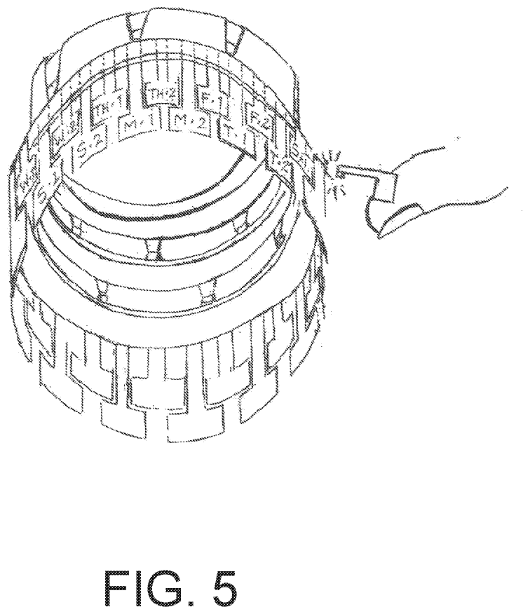

FIG. 5 is a representative perspective view of a pharmacy bottle cap with a single lock and a memory snap-tab system. Again, a user may press the tab away from the cap to break and remove it from the memory system.

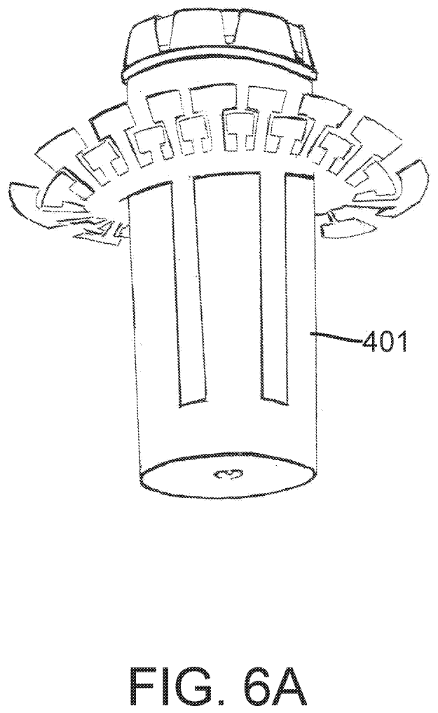

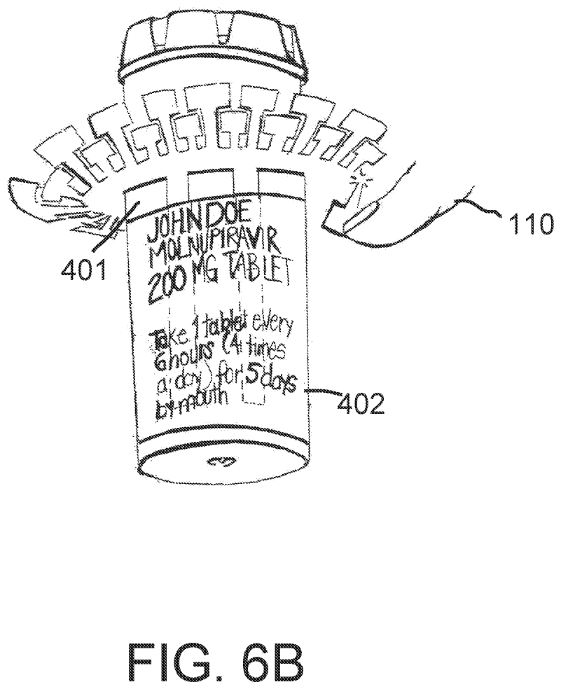

FIG. 6A is a representative perspective view of an embodiment of a pharmacy bottle with a sleeve and a memory snap system. In some embodiments, a sleeve 401 may be attached to the pharmacy bottle secured by elongated side-pins. The sleeve may contain built-in breakable memory snap tabs. Like FIG. 2A, the sleeve may project the removeable tabs so that the bottle is designed to resemble a COVID molecule for prescriptions related to COVID, for example.

Referring now to 6B, a representative perspective view of the embodiment of the pharmacy bottle with the sleeve 401 from FIG. 4A is illustrated in use by a user 110. The pharmacy bottle may have a label 402 applied by the pharmacist that is wrapped around the sleeve of the bottle. As previously illustrated, elongated side pins may be inserted and aimed towards the bottom of the bottle. The bottle as pictured in FIG. 4B may be designed to resemble the shape of a COVID molecule.

In some embodiments, a pharmacy bottle and/or cap with a built-in memory Snap-tab system is illustrated. The memory system may quickly and effectively communicate information to the user, as illustrated in the Figures. Removable tabs may serve as a practical, simple reminder to improve management of prescription medication schedule and help to prevent overdose or death. The Simple & Safe memory snap-tab system can easily be introduced into the “Friendly & Safe” bottle and/or cap manufactured by Berry Plastic Corporation. As such, the present disclosure can quickly and easily be introduced into Berry's existing manufactures high production injection molding methods with minor tooling modifications and/or new mold production.

In alternative embodiments, the smart pharmacy bottle and/or cap design with a built-in memory snap-tab system can be molded to resemble the image of the COVID Molecule for prescription medication. Such an embodiment can quickly and easily be adopted both nationally and internationally to save lives in the treatment of COVID. On Nov. 4, 2021, the United Kingdom became the first to approve Molnupiravir, and in mid-November, Bangladesh's Beximco Pharmaceuticals, based in Dhaka, started selling a generic version of the drug Molnupiravir. Finding an effective oral antiviral for the COVID disease has been a high priority for scientists around the world who want improve treatment of high-risk patients in the United States, but especially in rural areas or under-resourced countries. While research continues to develop multi-drug combinations for the ultimate treatment against SAR-CoV-2, national and international rollout of Paxlovid oral antiviral pills by Pfizer and Molnupiravir oral antiviral pills by Merck continues. Since the future for defeating COVID may rest on a dominated market of oral antiviral pills for the rapid increase and spread of infection and death by SAR-CoV-2 and variant's, the need to improve management of COVID and prescription medication schedules is at its all-time high, and the present disclosure comes at a time of real need.

In some embodiments, the smart pharmaceutical bottle may be made of thermoplastics including PEEK or Fluoropolymers (e.g., FEP and PFA). The smart pharmaceutical bottle may be made from any plastic commonly used in medical applications that have low extractables and leachables, are chemically inert, have lubricity, and desirable moisture barrier properties.

In some embodiments, the smart pharmaceutical bottle may be injected molded resulting in thin walls. Additionally, the bottle may come in various shapes, sizes, and colors. While only cylinder-shaped pharmacy bottles are shown within, the variety of shapes are almost endless. The pharmacy bottles can be rectangular or circular. The bottle caps or the cover for the opening in the pharmacy bottle could be of any type. The objective of the present disclosure is to communicate quickly and effectively as possible to the patient receiving the prescription bottle, creating the highest probability of being understood and made stupid simple for the patient memory.

The foregoing description details certain embodiments of the systems, devices, and methods disclosed herein. It will be appreciated, however, that no matter how detailed the foregoing appears in text, the systems, devices, and methods can be practiced in many ways. As is also stated above, it should be noted that the use of particular terminology when describing certain features or aspects should not be taken to imply that the terminology is being re-defined herein to be restricted to including any specific characteristics of the features or aspects of the technology with which that terminology is associated.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Headings are included herein for reference and to aid in locating various sections. These headings are not intended to limit the scope of the concepts described with respect thereto. Such concepts may have applicability throughout the entire specification.

Many variations and modifications may be made to the above-described embodiments, the elements of which are to be understood as being among other acceptable examples. All such modifications and variations are intended to be included herein within the scope of this disclosure. The foregoing description details certain embodiments. It will be appreciated, however, that no matter how detailed the foregoing appears in text, the systems and methods can be practiced in many ways. As is also stated above, it should be noted that the use of particular terminology when describing certain features or aspects of the systems and methods should not be taken to imply that the terminology is being re-defined herein to be restricted to including any specific characteristics of the features or aspects of the systems and methods with which that terminology is associated.

It will also be understood that, when a feature or element (for example, a structural feature or element) is referred to as being “connected”, “attached” or “coupled” to another feature or element, it may be directly connected, attached or coupled to the other feature or element or intervening features or elements may be present. In contrast, when a feature or element is referred to as being “directly connected”, “directly attached” or “directly coupled” to another feature or element, there may be no intervening features or elements present. Although described or shown with respect to one embodiment, the features and elements so described or shown may apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments and implementations only and is not intended to be limiting. For example, as used herein, the singular forms “a”, “an” and “the” may be intended to include the plural forms as well, unless the context clearly indicates otherwise. It will be further understood that the terms “comprises” and/or “comprising,” when used in this specification, specify the presence of stated features, steps, operations, processes, functions, elements, and/or components, but do not preclude the presence or addition of one or more other features, steps, operations, processes, functions, elements, components, and/or groups thereof. As used herein, the term “and/or” includes any and all combinations of one or more of the associated listed items and may be abbreviated as “/”.

Spatially relative terms, such as “forward”, “rearward”, “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features due to the inverted state. Thus, the term “under” may encompass both an orientation of over and under, depending on the point of reference or orientation. The device may be otherwise oriented (rotated 90 degrees or at other orientations) and the spatially relative descriptors used herein interpreted accordingly. Similarly, the terms “upwardly”, “downwardly”, “vertical”, “horizontal” and the like may be used herein for the purpose of explanation only unless specifically indicated otherwise.

Additionally, transitional phrases “consisting essentially of” and “consisting of” define the scope of a claim with respect to what unrecited additional components or steps, if any, are excluded from the scope of the claim. Clams using terminology “consisting of” are intended to exclude any element, step, or ingredient not specified in the claim. Claims using “consisting essentially of” limit the scope to the specified materials or steps and those that do not materially affect the basic and novel characteristics of the claimed invention.

Although various illustrative embodiments have been disclosed, any of a number of changes may be made to various embodiments without departing from the teachings herein. For example, the order in which various described method steps are performed may be changed or reconfigured in different or alternative embodiments, and in other embodiments one or more method steps may be skipped altogether. Optional or desirable features of various device and system embodiments may be included in some embodiments and not in others. Therefore, the foregoing description is provided primarily for the purpose of example and should not be interpreted to limit the scope of the claims and specific embodiments or particular details or features disclosed.

What is claimed is:

1. A pharmacy cap, comprising:
a body having a top surface and a continuous wall defining an inner surface and an outer surface;
an attachment feature positioned on the inner surface of the continuous wall, wherein the attachment feature may be removably coupled to a compatible feature on a bottle;
a ring affixed around the outer surface of the continuous wall, the ring further comprising a plurality of removable tabs indicating a set of dosage information to a patient; and
wherein the plurality of removable tabs is configured to be individually removed from the ring by the patient according to the set of dosage information.

2. A method for using a pharmacy system, the method comprising:
providing a plurality of removable tabs affixed to a medication container, wherein the plurality of removable tabs is arranged sequentially to indicate a set of dosage information to a patient;
removing, by the patient, a single tab from the plurality of removable tabs that corresponds to a dosage time based on the set of dosage information; and
wherein removing the single tab is performed iteratively based on the set of dosage information until the plurality of removable tabs is removed.

3. A pharmacy bottle, comprising:
a container having a base and a continuous wall defining an inner volume, the container further comprising an opening positioned opposite the base, the opening providing access to the inner volume;
a ring positioned around the continuous wall of the container externally to the inside volume, the ring further comprising a plurality of removable tabs indicating a set of dosage information to a patient; and
wherein the plurality of removable tabs is configured to be individually removed by the patient according to the set of dosage information.

4. The smart pharmacy bottle of claim 2, wherein the ring is shaped to resemble a virus molecule.

5. The smart pharmacy bottle of claim 2, wherein the set of dosage information is indicated to the patient through a set of textured characters on the plurality of removable tabs.

6. The smart pharmacy bottle of claim 4, wherein the set of textured characters comprises numbers and letters.

7. The smart pharmacy bottle of claim 2, wherein the removable tabs are aligned on a plane perpendicular to the continuous wall of the container.

8. The smart pharmacy bottle of claim 2, wherein the removable tabs are aligned on a plane parallel to the continuous wall of the container.
